(19) United States
(12) Patent Application Publication
(10) Pub. No.: US 2008/0281465 A1
(43) Pub. Date: Nov. 13, 2008

(54) Carwash merchandising system

(76) Inventor: Terry James Mulville, Markesan, WI (US)

Correspondence Address: Terry James Mulville, N 3698 State Highway 73, Markesan, WI, 53946, US

(21) Appl. No.: 11/801,759

(22) Filed: May 11, 2007

(51) Int. Cl. G06F 17/00

(52) U.S. Cl. 700/232

(57) ABSTRACT

The car wash system delivers not only the car wash selected by the customer but also provides a bonus product when a premium car wash selection is made. A second feature of this invention is the timing of the deliver of the bonus product. It must be delivered before the car wash cycle begins.

### BACKGROUND

The automatic self sever car wash industry has become increasingly competitive as service industries continue to grow. A key component to the car wash is the receipt of payment for the car wash. Control systems have been developed to receive coins, paper currency and credit cards to buy multiple items and return change as demonstrated by Levasseur U.S. Pat. Nos. 4,008,792 and 3,841,456. What these control systems lack is flexibility to deliver both a service, generally delivered at some distance from the control system and a product from one control system. Car wash control systems deliver the service of washing your car automatically with some extra features such as a wax treatment and/or under body flush. At some car wash operations you may also get personnel to clean the interior of your car which are also services. Again what is missing is the mixture of being able to receive a service and a product out of one control system.

Incentives in the car wash industry allow customers to receive extra value for an increased price above the basic car wash price. Incentives are generally options for the car wash service such as a wax treatment included in the wash and/or an underbody flush. What is still missing in the car wash industry is an option to select a bonus product or feature that can be received with the service feature to enhance the car wash experience.

The car wash and any incentives are always delivered during the car wash cycle. What is missing from commercial car wash systems is the ability to receive additional products for the car before the car wash cycle begins through one purchase of both product & service.

### BRIEF DESCRIPTION OF THE INVENTION

The present invention is a control system that will deliver a car wash service which may include any combination of exterior cleaning, waxing and or polishing and deliver an interior product such as a cleaning wipe, deodorant, fragrances or cleaning kit. The control system that delivers both the service feature and the product feature requires an electronic timing mechanism to not only deliver timing of the washing operation but also to dispense the bonus item before the car wash begins. It is preferred that the bonus product be delivered to the customer before that last customer has completed the car wash and drying. In this way the customer may use the product to clean, deodorize fragrance or polish up the interior of the car while the car is being washed, waxed and polished on the outside. A window of time for selection of the bonus product is an additional feature of this invention. The window begins when the customer makes payment for the car wash and ends when the car wash cycle begins and the customer enters the car wash.

In a specific embodiment of this invention, an exterior car wash may be purchased with the free bonus car interior item that may be selected from a group that is offered. In this embodiment, the customer is given a free bonus item of their choosing that will add value to the car wash experience.

Customers at car washes with this control system have several benefits including:
Receive both an exterior car wash and bonus product for the interior of the car with one purchase.
Have cleaning and freshening products for the interior of their car available and ready to use while their car is being washed or while waiting for an earlier customer to finish the wash cycle.
Able to receive both the car wash service and the bonus product with just one purchase.
Do not have to move or get out of their car to obtain these products.
Have a choice of products to use on the interior that suits their needs at the car wash site.
Have everything available to clean and freshen both the inside and outside of the car at the car wash site.
Able to clean and freshen inside the car before and during the car wash cycle.
Alerts the customer to select the free or bonus product before entering the car wash and even before the last customer has left the car wash.

Car wash vendors also have benefits that other systems do not deliver.
Offers bonus features that other car washes do not.
Bonus features offered with this control system can be included with more expensive washes increasing the sale of high priced washes delivering better profit margins.
Allows the sale of items that car wash customers would not normally purchase.
Advertising on many sides of the control system to deliver information about the car wash advantages.
Flexibility of the system to add additional vended products and services that are delivered on a timely basis for the customer's advantage.
Make the customers loyal to free items and help the sale of more expensive car washes.
The window of opportunity eliminates a second customer from selecting and receiving a free bonus product purchased by the previous customer who paid for but did not select a bonus feature.

### BRIEF DESCRIPTION OF THE DRAWING

FIG. 1. Flow control diagram of the car wash and vending control system

### DETAILED DESCRIPTION OF THE INVENTION

FIGURE one shows a payment controller similar to what is described in Levasseur U.S. Pat. Nos. 4,008,792 and 3,841,456. The payment controller accepts currency, debit cards or credit cards for payment of the car wash. The controller may return change and offer a receipt for the transaction. The payment controller sends a signal to the PLC, Programmable Logic Controller, once payment is received and a car wash option is selected. The PLC controls the queue of customers that have paid for the car wash and are waiting in line or currently in the car wash. The PLC also controls the bonus feature if purchasing one of the more premium car washes. When the premium car wash is selected and paid for by the customer, the PLC sends a signal to the Bonus Product Selector. The Bonus Product Selector is activated to alert and allow the customer to select a bonus product. Bonus products include, but are not limited to items used to clean and/or freshen the interior of the customer's car. Examples of bonus products include but are not limited to a cleaning towel, air freshener, deodorant, window cleaner, etc. Once the customer selects the bonus product desired, the Bonus Product Selector sends a signal to the PLC, which then sends a signal to the corresponding Product Dispenser. The Product Dispenser delivers the bonus product to the customer. The PCL controls the timing of the delivery of the product so that the customer may receive the product for cleaning the interior of the car before the car wash cycle begins even if an earlier customer is still in the car wash. This allows the customer to clean and/or freshen the interior of the car before and/or during the wash for the car's exterior.

The PLC may have a delay feature for the car wash to assure that adequate time is allowed for the customer select and receive the bonus product before the car wash cycle begins. An adequate delay time may be between 10 seconds and 10 minutes. This delay is critical in that the customer must be aware of the ability to select and receive a bonus feature before the customer is asked to drive into the car wash. Without the time delay, confusion on the customer's part during this transaction may make him forget his bonus product. For example, if the “enter” light flashes for the car wash before or at the same time as the “please select a bonus product light, the customer may drive ahead without the bonus product.

The PLC may also have a window of opportunity for the customer to select the bonus feature. The window of opportunity for selection of the bonus feature must begin as soon as payment is made for the car wash to allow the customer to collect the product and potentially start to use it before the car wash begins. This is important to the customer to allow him/her to use the product while waiting for the previous customer to leave the car wash or to use the product during the car wash instead of just waiting in line and waiting in the car wash. The window of opportunity is closed once the car wash cycle begins. Closing the window of opportunity before the second customer is allowed to select and receive the first customer's bonus prevents the second customer from receiving a free bonus product, which was paid for, by the first customer. If the window does not close the second customers may think that he should always get a bonus independent of the car wash purchased. The window in the invention is closed when the car moves away from the payment controller, enters the car wash or when the wash cycle begins,

The PLC may be purchased from McMaster Carr Supply Company of Chicago, Ill. where the size can be selected to meet the number of functions needed to match the number of car wash selections and bonus features offered. The PLC must be programmed with the logic to activate the Bonus Product Selector by an electrical engineer. The program activates the switches and can alert the customer to make a selection from the Bonus Product Selector switches. Once the customer makes a selection from the Bonus Product Selector panel, the PLC deactivates the switches and sends a signal to the appropriate Product Dispenser. Programming is also needed for the delay and window of opportunity features.

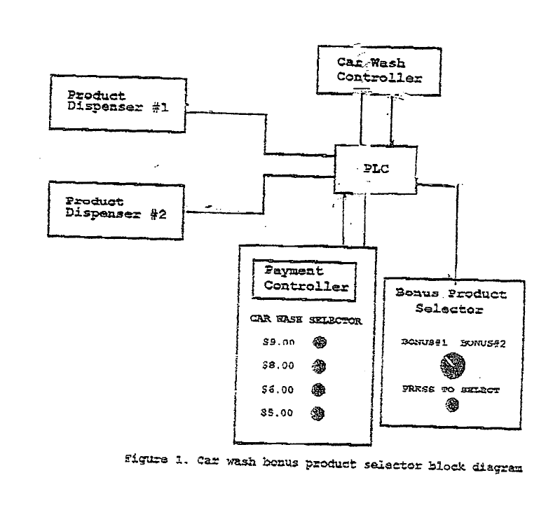

This invention includes the complete system with all the components shown in FIG. 1 or may be added on to an existing car wash. For example, the Bonus Product Selector panel may be combined with the Payment Controller as one unit or may be a stand-alone that can be incorporated into an existing car wash. Similarly, The PLC may be incorporated with the payment controller or be a stand-alone unit that can be added on to an existing car wash. This allows car wash vendors the option of purchasing the entire system or upgrading their existing car wash system to offer the bonus products.

The Bonus Product Selector is a simple electrical box with simple circuit closing buttons that allows customers to select the bonus product. Additionally in the Bonus Product Selector a lighted display may be added to alert the customer to make the selection. The PLC optimally activates the Bonus Product Selector buttons and lights a display that reads please select your bonus product.

A simple system would have only one bonus product and it would be dispensed without requiring the customer to select from a few options. Again the product must be dispensed before the car wash cycle begins.

Bonus Product are not limited to cleaning and freshening the interior of the car but may also be other items of value that may included free soda or snacks.

The product dispenser can be made from vending equipment that can stand up to the exterior environment. Laurel Metal Products can supply the product dispenser for this system. The height of the deliver system is critical for car wash customers. The height or the delivered bonus product must be between 60 cm. and 340 cm. to allow the customer to reach the product without getting out of the car. An ideal height for most vehicles would be about 125 cm.

Lighting and information for the car wash is helpful to the customer. Since a power supply is available for the PLC and Payment Controller, that power may also be used to add additional signage on surfaces other than the one facing the customer. For example, a sign for the free bonus product with the premium wash could be placed on the drive up facing surface of the Payment Controller. This adds an advertising feature for the bonus washes. Similarly, this same message could be displayed on the back of the payment Controller to alert potential customers driving past as to the advantage of this car wash system over competitors.

The car wash system requires a menu board that describes the car wash options, bonus product options and how to obtain the bonus product options. This information may be displayed on the customer-facing surface of the Payment Control and/or Bonus Product Selector panels.

Assembly and programming car wash control system can be done by any qualified electrical engineer.

1. A car wash and vending control system that delivers, through one purchase, a vended product that can be used to clean or freshen the interior of the car and an exterior car cleaning service that is automatic.

2. Claim 1, where the product for the interior is delivered before the car wash cycle begins.

3. Claim 1, where the car wash control system offers at least one car wash selection that includes a free bonus product to clean or freshen the interior of the car with the purchase of a car wash.

4. Claim 1, where the car wash control system offers at least one car wash selection that includes a choice of at least 2 bonus product options where at least on of the options can be used to clean or freshen the interior of the car.

5. Claim 3, where the car wash control system offers at least one selection that does not include a bonus product.

6. Claim 1, where the vended product is available at the site where the car wash is purchased.

7. Claim 5, where the vended product is delivered at a height between 60 cm. and 340 cm. so the customer does not have to leave his car to purchase the car wash and receive the bonus product.

8. Claim 1 where the control system supplies power for at least one lighted menu board that describes the car wash and/or bonus options.

9. Claim 8 where the menu board is attached to the control system.

10. Claim 1 where the control system has a lighted information sign on the surface opposite the vending selection options.

11. Claim 10 where lighted information is available on more that 2 sides of the control system.

12. Claim 1 where all components, including a timing control mechanism, are controlled by one PLC control panel

13. Claim 1 where at least one additional PLC is used to control the vending portion of the car wash system

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. A car wash and vending control system that delivers a vended product that may be used to clean or freshen the interior of the car composed of a traditional automatic carwash with automatic wash, rinse, drying and payment control equipment that is interfaced with an adjacent vending machine with a product dispenser within proximity of the payment control equipment that allows the purchase of a car wash and delivery of the vended product within hand reach of the of the customer and a Programmable Logic Controller that links the carwash functions with the vending system to offer a combination of purchase options and delivers the product before the car wash cycle begins and programming of the logic controller that links the car wash purchase and the delivery of vended product.

17. Claim 16, where the car wash control system offers at least one car wash selection that includes a free bonus product to clean or freshen the interior of the car with the purchase of a car wash.

18. Claim 16, where the car wash control system offers at least one car wash selection that includes a choice of at least 2 bonus product options where at least one of the options can be used to clean or freshen the interior of the car.

19. Claim 17, where the care wash control system offers at least one selection that does not include a bonus product.

20. Claim 16, where the vended or bonus product is delivered at a height between 60 cm. and 340 cm.

21. Claim 16, where the control system has at least one lighted menu board that describes the car wash and/or bonus options.

22. Claim 21, where the menu board is attached to the control system.

23. Claim 16, where the control system has a lighted information sign on the surface opposite the vending selection options.

24. Claim 23, where lighted information is available on more than 2 sides of the control system.

25. Claim 16, where the car wash system has a window of opportunity for the customer to select the bonus product.

26. Claim 16, where all components are controlled by one PLC control panel.

27. Claim 16, where at least one additional PLC is used to control the vending portion of the car wash system.

28. Claim 16, where the control system has programming for a delay time for the customer to select collect and/or use the bonus product before the car wash begins where.

29. Claim 16, where the control system has programming to allow the product and the service to be purchased with a single payment.

30. A process that delivers vended interior car cleaning and freshening products to customers when the customer is at the payment control equipment for the car wash before the car wash cycle begins and allows the customer to begin cleaning or freshening of the interior of the car without exiting the car or moving the car out of the car wash cycle queue.

31. Claim 30, where the process delivers at least one bonus product with purchase of a car wash.

32. Claim 30, where the process has a delay time for the customer to select collect and/or use the bonus product before the car wash begins where the delay is less than 10 minutes.

33. Claim 31, where the process delivers the bonus product before the last customer completes washing/drying of the previous car.

34. Claim 31, where the process alerts the customer to select the bonus product.
